(19) United States
(12) Patent Application Publication
(10) Pub. No.: US 2023/0356780 A1
(43) Pub. Date: Nov. 9, 2023

(54) FRAME CROSS MEMBER FOR BATTERY ELECTRIC VEHICLE

(71) Applicant: TROVA COMMERCIAL VEHICLES INC, Fairlawn, VA (US)

(72) Inventors: Patrick COLLIGNON, Fairlawn, VA (US); Maxell COLLIGNON, Fairlawn, VA (US)

(21) Appl. No.: 18/245,431

(22) PCT Filed: Sep. 13, 2021
(86) PCT No.: PCT/US21/49998

§ 371 Date: Mar. 15, 2023

Related U.S. Application Data
(60) Provisional application No. 63/079,731, filed on Sep. 17, 2020.

(51) Int. Cl. B62D 21/03; B60K 1/04; B62D 21/09

(52) U.S. Cl. CPC B62D 21/03; B60K 1/04; B62D 21/09

(57) ABSTRACT

A u-shaped crossmember is employed in the construction of a chassis frame of a medium or heavy duty battery electric vehicle. In the design, frame rails are joined by at least one of U-shaped cross members, which comprises a main center section and four or more support arms, which extend away from the main center section of the cross member in the transverse direction of the longitudinal frames. The cross members, in one example, include two brackets. Each bracket has two arms connected by a center main portion. These brackets can be fabricated by creating a plurality of angles in several locations that add up to 90-degrees. The angled design allows the transmission of longitudinal and lateral forces to both frame rails. Due to U-shaped nature of the cross member, the body of the chassis frame is opened to allow for installation of components, subassemblies, and especially battery packs, etc.

### RELATED APPLICATIONS

This application claims the benefit under 35 U.S.C. § 119(e) of U.S. Provisional Application No. 63/079,731 filed on Sep. 17, 2020, which is incorporated herein by reference in its entirety.

### FIELD OF THE INVENTION

The present invention relates to a chassis frame of a battery electric vehicle comprising one or more U-shaped cross-members. These cross-members are connected to two longitudinal frame rails, and make up the body of the chassis frame. These longitudinal frame rails have, for example, a L-shaped or C-shaped cross section, and can be doubled up for certain applications. The present invention also encompasses a U-shaped cross-member that opens up the body of the chassis frame by fastening to the frame rails respectively and provides rigidity both in the longitudinal and the lateral direction.

### BACKGROUND OF THE INVENTION

In the medium and heavy-duty truck industry a typical chassis frame often consists of two lateral frame rails running in the longitudinal direction of the vehicle. Within this industry, it is a recognized practice to double up on the frame rails, with for example an L or a C shape, to increase strength and load bearing capacity. Each side of the chassis frame will then consist of one larger outer frame rail with an inner and outer surface, and one smaller inner frame rail with an inner and outer surface. This inner frame rail is oriented in the same direction as the outer frame rail so as the outside surface of the inner frame rail touches the inside surface of the outer frame rail as to provide underlying support. At least one cross-member is then mounted between the lateral frame rails to provide rigidity to the frame. Within the industry, such chassis frame is utilized to attach components or subassemblies (multiple components assembled prior to final mounting) to the chassis vehicle. Within this industry, it is a recognized practice to utilize cross members that are located on the inside of the chassis frame, i.e. they have cross members with two outer surfaces that join up to the inner surfaces of the frame rails to make up the body of the chassis frame. Such cross members are designed to stiffen the frame.

Such traditional types of cross-members are disclosed in the following patents, resp. patent applications:
JP 2002362410 A 20021218 relating to an automobile chassis frame, by Press Kogyo K K, disclosing a chassis frame comprising a pair of right and left side member (longitudinal frame rails), connected by a plurality of cross members, positioned at the inside of said side members;
JPH06191434 A 19940712 relating to an under carriage frame of truck and the like, by Mitsubishi Motors Corp, disclosing also side rails connected by cross members, positioned at the inside of said side members.

Traditional types of crossmembers eliminate the possibility of component installation between the chassis rails from the forward-facing or rear-facing ends of the chassis frames, and instead, need to be accessed from the upper or lower direction. Within the battery electric industry, access to battery packs that get mounted between the frame rails of the vehicle are not easily accessible post-production for maintenance or replacement. This lack of easy access causes numerous problems, in particular during maintenance or replacement operations.

Within the prior art, chassis frames are disclosed comprising longitudinal frame rails connected by U-shaped cross members; examples hereof are disclosed in the following patents, resp. patent applications:
EP 0940323 A1 19990908, relating to a chassis for a heavy-duty utility vehicle, by Man Nutzfahrzeuge, A G, disclosing two (longitudinal) chassis members linked by a LI-shaped cross member; in this case however, the cross-members are part of a suspension system comprising springs and telescopic dampers;
DE19624242 A1 19970918, relating to a vehicle front wheel suspension system, by Daimler Benz A G, disclosing also a U shaped cross member within a front wheel suspension system;
EP 0940325 A1 19990908, relating to a chassis for a heavy duty utility vehicle, by Man Nutzfahrzeuge A G, disclosing a chassis comprising a frame and a three-part U-shaped cross stretcher within a suspension system for the vehicle;
EP 2363336 A1 20110907, relating to a chassis of a forward control truck with a tiltable cab, by Iveco Magirus, Germany, disclosing a chassis comprising a frame with two longitudinal members and at least one traverse member, within a suspension system for a tiltable cab.

These chassis frames and U-shaped cross members generally relate to systems for independent wheel suspension as used in commercial vehicles. As such they do not yield the stiffness and space required for easily storing and accessing the electric battery packs within the frames of electric battery vehicles. As such these systems do not yield a satisfactory solution for the abovementioned problems and disadvantages.

### SUMMARY OF THE INVENTION

The present invention comprises a u-shaped crossmember for the construction of a chassis frame of a medium or heavy-duty battery electric vehicle, In embodiments of the chassis frame configured as described below, the frame rails are joined by at least one Li-shaped cross member that comprises a main center section (41) and four or more support arms (35). These support arms extend away from the main center section of the cross member in the transverse direction of the longitudinal frames. These arms each have an outer surface (35) and an inner surface (34) that are perpendicular with the center main portion of the cross member and are parallel with the longitudinal frame rails. The outer surface faces away from the center main portion of the cross member, and the inner surface faces towards the center main portion, which allows it to be fastened onto the outside surface of the longitudinal frame rails. Due to the U-shaped nature of the cross member, the body of the chassis frame is opened to allow for installation of components or subassemblies to the inside of the frame rail through a variety of mounting techniques.

In an embodiment of the invention, the U-shaped cross member is created by the fabrication of two identical brackets who are then inversed to each other and fastened through means of, but not limited to, nuts and bolts (42). Each U-shaped cross member then might have of a main center section and two upright support arms on either side of the main center section extending in the transverse direction of the frame rails as such they will be able to bolt to the outside surface of the longitudinal frame rails.

In an advantageous embodiment of the invention, each of the two brackets of the U-shaped cross member is created from a single piece of steel, bent in a plurality of angles in several locations adding up to 90 degrees on either side of the bracket. To describe the current invention, a 45-degree angle in two different locations on either side of the bracket for a total of four bends per bracket, shall be used. This series of bends allows the creation of two perpendicular edges to the center main portion of the cross member. These two brackets then get fastened to each other, eliminating the need for extensive manufacturing processes such as welding, while the cross member adds stiffness, both in torsion and in bending to the frame. Due to its angular design, the crossmember can transfer lateral and tangential forces to both frame rails, Moreover, the cross member can be manufactured in a very cost-effective way.

In general, according to one aspect, the invention features a chassis frame structure for a battery electric vehicle comprising two or more longitudinal frame rails (12) and at least one U-shaped cross member (11), made up of two brackets, each bracket comprising a main center section (33) and two upright support arms (35), each uptight support arm linked to the main center section through a plurality of angular bends (34), the main center section wherein each cross member comprises a main center section facing in the longitudinal direction of the chassis frame, the four outer support arms facing in the transverse direction of the chassis frame.

Each bracket can contain a total of four 45-degree bends (34), two on each upright support arm 35.

And, each support arm can have an inner surface (31) facing the longitudinal frame rail so as the crossmember can be fastened to the outside surfaces of the longitudinal frame rails.

In some cases, the angular bends add up to 90 degrees and each support arm might have an outer and inner surface facing the transverse direction of the longitudinal frame rails.

In general according to one aspect, the invention features a method for manufacturing a battery electric vehicle comprising fabricating a chassis frame structure from two or more longitudinal frame rails (12) and at least one U-shaped cross member (11) and mounting batteries for the battery electric vehicle in a space between the upright support arms.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention.

Any advantages and industrial significances of the present invention will be described with reference to embodiments shown on the following drawings, on which:

FIG. 1 shows a perspective view of a chassis frame using three of the U-shaped crossmembers, described per an embodiment of the invention, fastened on the outside edges of the chassis rails.

FIG. 2 shows a frontal view of a chassis frame using one or more of the shaped crossmembers described per an embodiment of the invention, fastened on the outside edges of the chassis rails. It is clear to see the center of the rails is opened up through the use of said U-shaped crossmembers.

FIG. 3 shows a perspective view of one of the brackets that make up the structure of the U-shaped crossmember.

FIG. 4A-4D shows a variety of views of the U-shaped crossmember comprised of two identical brackets.

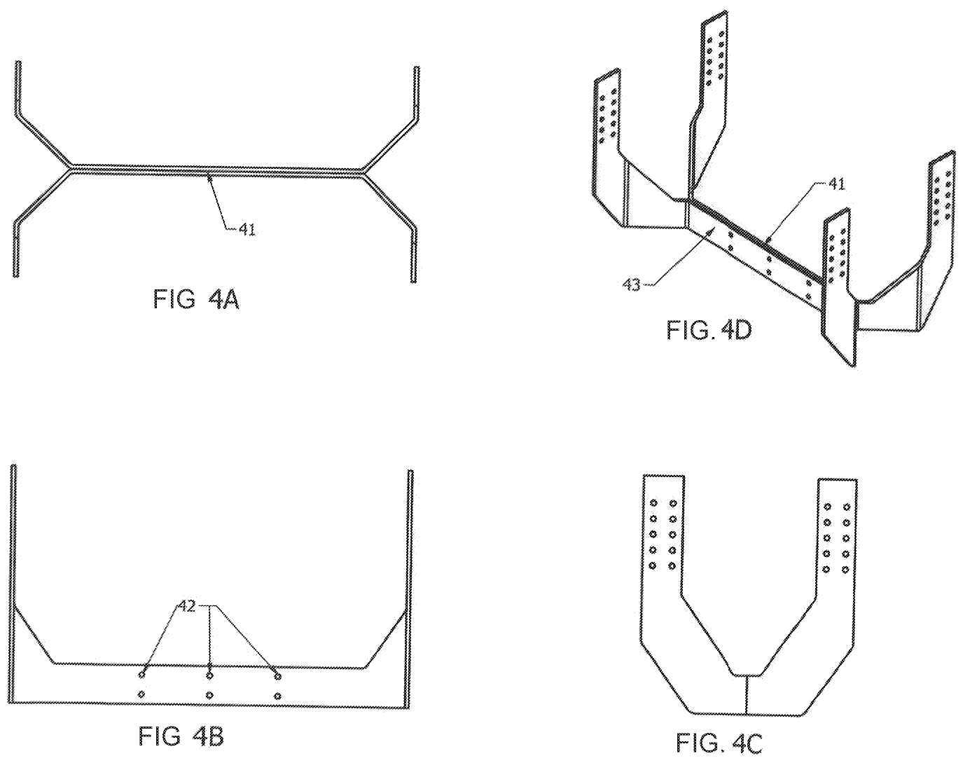

In the figures, the following reference signs denote the following parts:
11 denotes a U-shaped cross member;
12 denotes a longitudinal frame rail;
13 denotes fasteners enabling an arm of a bracket to join to the outside surface 14 of a longitudinal frame rail 12;
14 denotes the outside surface of a longitudinal frame rail 12;
15 denotes the inside surface of a longitudinal frame rail 12;
31 denotes the inner surface of the support arm 35 of a bracket of the U-shaped cross member 11;
32 denotes the outer surface of the support arm 35 of a bracket of the U-shaped cross member 11;
33 denotes the main center section of a bracket of the U-shaped cross member 11;
34 denotes a 45-degree bend;
35 denotes an upright support arm of a bracket of the U-shaped cross member 11;
36 denotes the inner surface of the main center section of a bracket;
41 denotes touching two inner surfaces of two brackets;
42 denote fasteners enabling two brackets to join to form the U-shaped cross-member 11;
43 denotes the outer surface of the main center section of a bracket of the U-shaped cross member 11.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the term “and/or” include any and all combinations of one or more of the associated listed items. As used herein, the singular forms “a,” “an,” and “the” are intended to include the plural forms as well as the singular forms, unless the context clearly indicated otherwise. It will be further understood that the terms “comprises” and or “comprising,” when used in this specification, specify the presence of stated features, steps, operations, elements, and/or components, but do not preclude the presence or addition of one or more other features, steps, operations, elements, components, and/or groups thereof.

It will be understood that although terms such as “first” and “second” are used herein to describe various elements, these elements should not be limited by these terms. These terms are only used to distinguish one element from another element. Thus, an element discussed below could be termed a second element, and similarly, a second element may be termed a first element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

A chassis frame comprising of a plurality of one or more U-shaped cross members and two longitudinal frame rails, is discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or descriptions below.

The present invention will now be described by referencing the appended figures representing preferred embodiments.

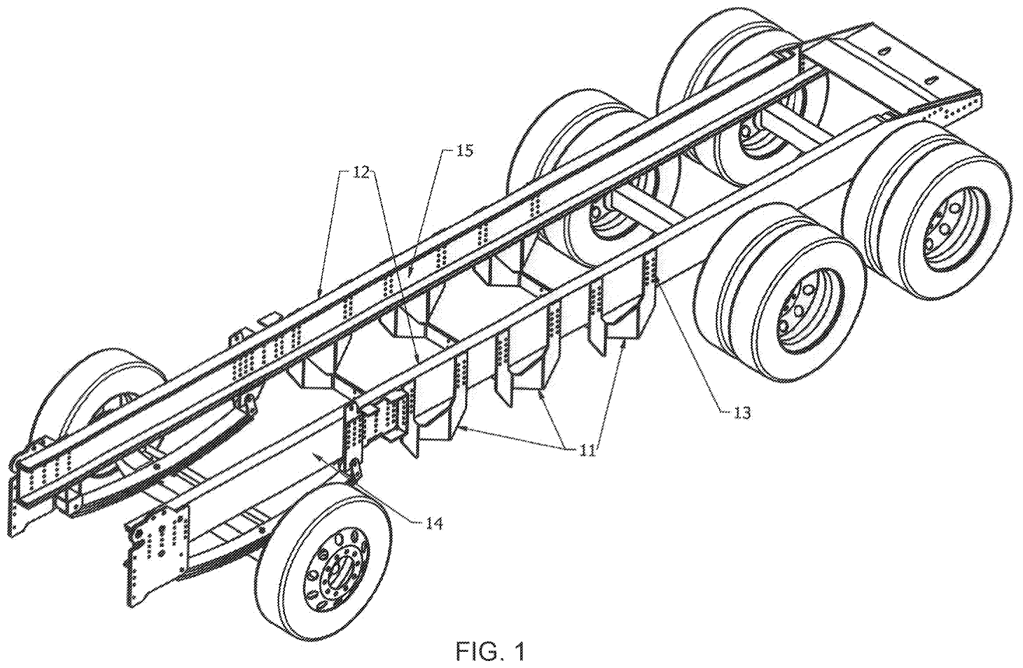

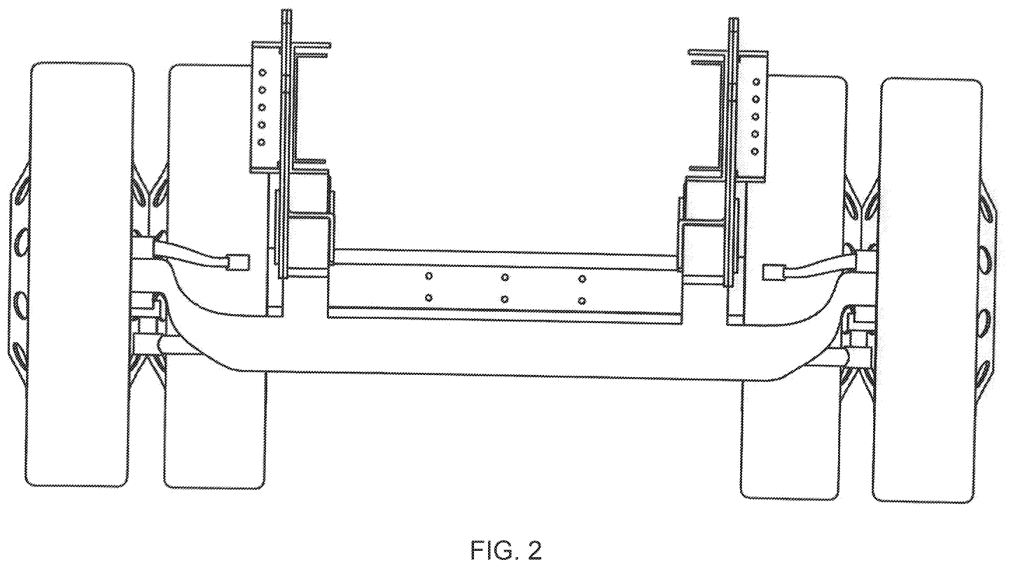

FIG. 1 depicts a perspective view of an example of a chassis frame comprised of one or more U-shaped cross members 11 and two longitudinal frame rails 12. The chassis frame structure may contain a plurality of such U-shaped cross members 11 along the length of the vehicle to add structural strength and add stiffness both in torsion and in bending to the frame. They are added where needed as to distribute any forces acting on the frame, to both longitudinal frame rails 12, while opening the space between the chassis rails to, for example, electric drivetrain and batteries or other components as can be seen on FIG. 2. The specific chassis frame depicted in FIG. 1 comprises three cross members 11.

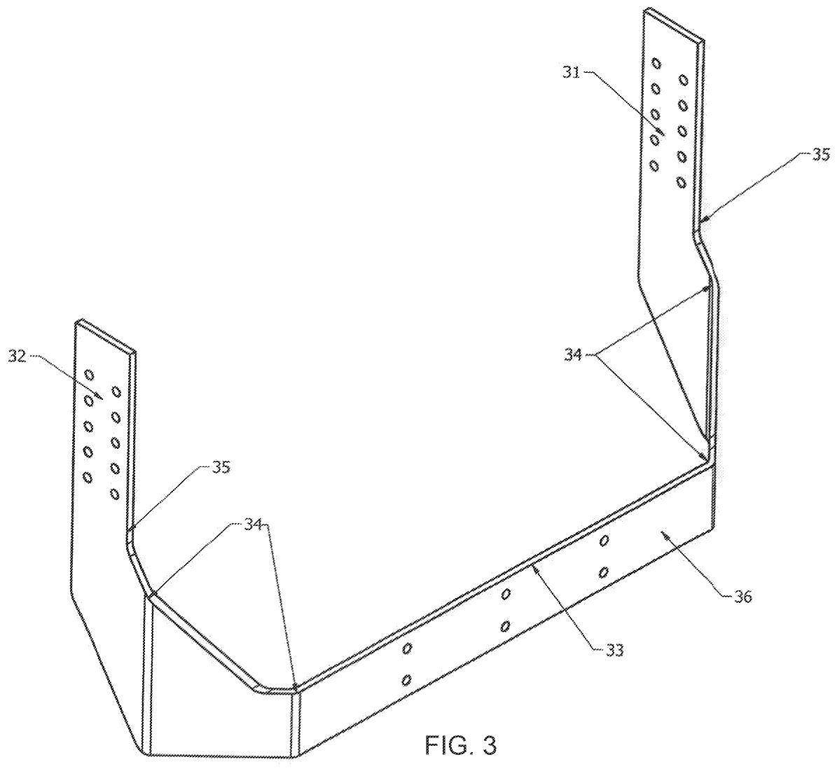

Referring now to FIG. 3, in an advantageous embodiment of the invention, each U-shaped cross member 11 comprises two identical brackets. One of these brackets is depicted in FIG. 3. These brackets can easily be created through simple manufacturing processes such as stamping and bending on a press break, allowing the brackets to be manufactured in very cost-effective ways. Each bracket contains a plurality of angular bends adding up to 90-degrees on each side of the upright support arms 35 in order to create lateral and tangential strength. In this particular example, each bracket contains a total of four 45-degree bends 34, two on each upright support arm 35. The bends cause the creation of a main center section 33 that is perpendicular to two upright support arms 35, These support arms 35 extend away from the main center section 33 of the cross member in the transverse direction of the longitudinal frame rails 12. The support arms 35 each have an outer surface 32 and an inner surface 31 that are perpendicular with the center main portion 33 of the cross member, and are parallel with the longitudinal frame rails 12.

In an advantageous embodiment of the invention, FIG, 4A through 4D show a variety of drawings of the U-shaped crossmember, comprised of two identical brackets as shown in FIG. 3. This allows for a part number reduction, and simplifies the manufacturing process. Two of said brackets as shown in FIG. 3 are inversely joined or joined back-to-back through fasteners 42. Each bracket has a main center portion 33 comprising an inner surface 36 and outer surface 43 that face the longitudinal direction of the chassis frame 12, and two support arms 35 extending into the bracket's main center portions outer plane. Said two brackets are joined by inversely turning them in the xy-plane 180-degrees as so the inner surfaces of each bracket are touching 41 and then joined through fasteners 42 such as, but not limited to, bolts and nuts and rivets, and the support arms 35 are facing away from each other along the longitudinal direction of the chassis frame 12.

According to an embodiment of the invention, the outer surfaces 32 of the support arms face away from the main center section 33 of the cross member, in the transverse direction of the longitudinal frame rails, and the inner surfaces 31 face towards the center main portion 33, as to allow the cross member to be mounted to the outside surface 14 of the longitudinal frame rails. Due to the elimination of mounting cross members on the inside surface 15 of the longitudinal frame rails, the center of the chassis frame is opened as shown on FIG. 2 which is particularly advantageous in the construction of electric vehicles in order to install, components or subassemblies within said chassis frame through the front facing or rear facing side of the chassis frame by means of a variety of mounting techniques

While this invention has been particularly shown and described with references to preferred embodiments thereof, it will be understood by those skilled in the art that various changes in form and details may be made therein without departing from the scope of the invention encompassed by the appended claims.

1. A chassis frame structure for a battery electric vehicle comprising two or more longitudinal frame rails and at least one U-shaped cross member, made up of two brackets, each bracket comprising a main center section and two upright support arms, each upright support arm linked to the main center section through a plurality of angular bends, the main center section wherein each cross member comprises a main center section facing in the longitudinal direction of the chassis frame, the four outer support arms facing in the transverse direction of the chassis frame.

2. The chassis frame structure according to claim 1, wherein each bracket contains a total of four 45-degree, two on each upright support arm.

3. The chassis frame structure according to claim 1, wherein each support arm has an inner surface facing the longitudinal frame rail so as the crossmember can be fastened to the outside surfaces of the longitudinal frame rails.

4. The chassis frame structure according to claim 1, wherein the angular bends add up to 90 degrees.

5. The chassis frame structure according to claim 1, wherein each support arm has an outer and inner surface facing the transverse direction of the longitudinal frame rails.

6. A method for manufacturing a battery electric vehicle comprising:
fabricating a chassis frame structure from two or more longitudinal frame rails and at least one U-shaped cross member; and
mounting batteries for the battery electric vehicle in a space between the upright support arms.

7. The method of claim 6, wherein the U-shaped cross member comprises two brackets, each bracket comprising a main center section and two upright support arms, each upright support arm linked to the main center section through a plurality of angular bends.
